(19) United States
(12) Patent Application Publication
(10) Pub. No.: US 2026/0021478 A1
(43) Pub. Date: Jan. 22, 2026

(54) Sulfidized Nanoscale Zerovalent Metal Doped Carbon Substrate for Poly- And Perfluoroalkyl Substances (PFAS) Adsorption and Transformation

(71) Applicant: Yiming SU, Logan, UT (US)

(72) Inventor: Yiming SU, Logan, UT (US)

(73) Assignee: Utah State University, Logan, UT (US)

(21) Appl. No.: 19/273,506

(22) Filed: Jul. 18, 2025

Related U.S. Application Data
(60) Provisional application No. 63/673,597, filed on Jul. 19, 2024.

(51) Int. Cl. B01J 27/043; B01J 20/20; B01J 20/32; B01J 21/18; B01J 23/80; B01J 35/30; B01J 37/02; B01J 37/16; B09C 1/08; B09C 1/10; C02F 1/28; C02F 1/70; C02F 1/72; C02F 101/36

(52) U.S. Cl. CPC B01J 27/043; B01J 20/20; B01J 20/3204; B01J 20/3217; B01J 21/18; B01J 23/80; B01J 35/394; B01J 37/0219; B01J 37/16; B09C 1/08; B09C 1/10; C02F 1/288; C02F 1/705; C02F 1/725; B09C 2101/00; C02F 1/283; C02F 2101/36; C02F 2305/023

(57) ABSTRACT

A nanoscale, metal-doped carbonaceous material and method of using such material to break down poly- and perfluoroalkyl substances (PFAS). The material can include a carbonaceous particulate matrix made of a carbon substrate, an oxidative metal, and a reductive metal. The method of breaking down. The method involves adsorbing PFAS with a metal-doped carbonaceous material, where the metal-doped carbonaceous material can be made of a carbon substrate, an oxidative metal, and a reductive metal, and degrading and reducing the PFAS.

### CROSS REFERENCE TO RELATED APPLICATIONS

This application claims priority to U.S. Provisional Patent Application No. 63/673,597, filed Jul. 19, 2024, which is incorporated herein by reference in its entirety.

### STATEMENT REGARDING FEDERALLY SPONSORED RESEARCH OR DEVELOPMENT

Not applicable.

### BACKGROUND

Poly- and perfluoroalkyl substances (PFAS) are a large, complex group of synthetic chemicals that have been used in consumer products around the world since about the 1950s. PFAS are associated with a variety of negative health effects including liver disease, kidney disease, damage to reproductive health, and cancer. Despite their toxicity, PFAS are used in a wide range of products and have been found in water, soil, agricultural goods, and the human body. PFAS molecules have a chain of linked carbon and fluorine atoms. Because the carbon-fluorine bond is one of the strongest, these chemicals do not degrade easily in the environment.

### SUMMARY

A metal-doped carbonaceous material can include a carbonaceous particulate matrix. The carbonaceous particulate matrix can be formed of a carbon substrate, an oxidative metal, and a reductive metal.

A method of breaking down poly- and perfluoroalkyl substances (PFAS) can include adsorbing PFAS with a metal-doped carbonaceous material. The metal-doped carbonaceous material can include a carbonaceous particulate matrix that includes a carbon substrate, an oxidative metal, and a reductive metal. The method can also include oxidizing and reducing the PFAS.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic illustration of an exemplary metal-doped carbonaceous particulate matrix.

FIG. 2 is a flowchart for a method of breaking down PFAS in accordance with another example.

FIG. 3A is an SEM image of S—Fe/Zn—B in accordance with one example.

FIG. 3B is an elemental analysis of the material in FIG. 3A.

FIG. 4 shows the defluorination of perfluorooctanoic acid (PFOA)/perfluorooctane sulfonic acid (PFOS) on S—Fe/Zn nanoparticles in accordance with another example.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a metal” includes reference to one or more of such materials and reference to “the catalyst” refers to one or more of such catalyst.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Example PFAS Adsorption and Degradation Materials and Methods

An initial overview of invention embodiments is provided below and specific embodiments are then described in further detail. This initial summary is intended to aid readers in understanding the technological concepts more quickly, but is not intended to identify key or essential features thereof, nor is it intended to limit the scope of the claimed subject matter.

The present disclosure relates to breaking down PFAS, which can be found in the environment. In particular, embodiments of the present disclosure include materials and methods for breaking down PFAS. As a general guideline, an effective method of removing PFAS from soil and water can be performed using a doped carbon substrate, for example biochar, carbon nanotubes or colloidal activated carbon, to adsorb and transform the PFAS. In another example, a biochar soil amendment can adsorb both short and long-chain PFAS, thereby limiting their uptake into agricultural crops. In another example, this material can be used in anaerobic digestion in municipal wastewater treatment and sludge composting to significantly reduce PFAS concentration in final biosolids.

In one example, this result can be achieved by doping metal oxide, metal sulfide, zero valent metals, and sulfidized zero valent metals, or any combination thereof, on the carbon substrate. These materials allow for the preferential adsorption of long and short chain PFAS, which occurs via electrostatic interaction. Subsequent to adsorption, the PFAS can be reduced and/or oxidized. Generally, PFAS reduction occurs under anaerobic conditions while oxidation takes place under acrobic conditions or with the dosage of oxidants, such as H₂O₂. Overall, this technology can effectively limit PFAS uptake into the agricultural food chain and reduces harmful effects of these persistent chemicals on humans.

It is noted that when discussing the compositions and methods described herein, these relative discussions can be considered applicable to the other examples, whether or not they are explicitly discussed in the context of that example. Thus, for example, in discussing a carbonaceous particulate matrix in a particular composition, such disclosure is also relevant to and directly supported in the context of a method of breaking down PFAS described herein, and vice versa.

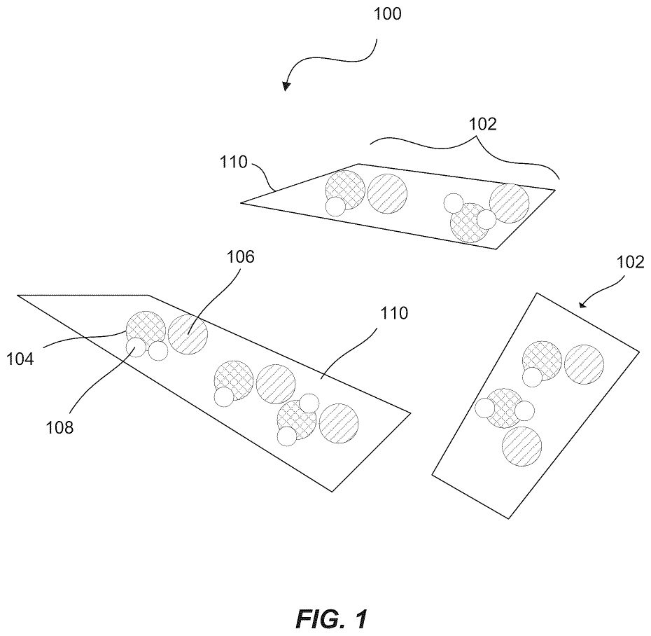

FIG. 1 shows a schematic view of an exemplary embodiment of the metal-doped carbonaceous material 100, which can include a carbonaceous particulate matrix 102. In some examples, the carbonaceous particulate matrix 102 can include a carbon substrate 110, an oxidative metal 104, and a reductive metal 106. The carbon substrate 110, which can make up the carbonaceous particulate matrix 102, can be any suitable material so as to create a porous matrix. Non-limiting examples of suitable carbon substrate materials can include carbon nanotube, (nano) graphene/graphite, activated carbon, carbon black, biochar, and other conductive materials with large surface areas, such as silica-base and/or zeolite-base material. In some examples, carbon substrates 110 can be a particulate material that is microscale, having an average particle size of 0.1 μm to 1 mm. In other examples, the particulate material can be nanoscale, having an average particle size of 1 nm to 100 nm. In further examples, the particulate material can have an average particle size of 1 mm to 100 mm. Carbon substrate 110 materials can also be conductive and surface property tunable (hydrophilic vs hydrophobic, adding surface functional groups for PFAS adsorption and electron transfer). These carbon substrates 110 can also be porous materials which allows the metals and other materials to be attached within a porosity of the particles. This can further increase active surface area where PFAS-containing fluids can pass and contact the carbon substrate 110 in combination with the oxidative and reductive metals.

In a specific example, the carbon substrate 110 can be biochar. Biochar is a charcoal and carbon-rich material produced by partial oxidation of carbonaceous organic sources such as wood and plants. As a porous carbonaceous solid, biochar has physiochemical properties suitable for the safe and long-term storage of carbon in the environment and soil improvement.

The oxidative metal 104 can be doped onto the carbon substrate 110 through precipitation, reduction (e.g. in tube furnace or liquid by reductant, such as NaBH₄), or ball milling. Typically, the oxidative metal 104 can be distributed at least on surfaces of the carbon substrate 110 or within porosity of the carbon substrate 110. In either case, as PFAS is adsorbed onto surfaces adjacent to or coming into contact with the oxidative metal 104, the oxidative metal 104 generates hydroxyl radicals from the PFAS. Oxidative metals can be chosen to react with the PFAS in the presence of oxygen to form hydroxyl radicals and partially degrade PFAS. Non-limiting examples of suitable oxidative metals can include iron (Fe) oxides (e.g. Fc²⁺ or Fe³⁺), nickel (Ni) oxide (e.g. Ni²⁺), copper (Cu) oxide (e.g. Cu⁺ or Cu²⁺), or combinations thereof. Oxidative metals 104 can be present in the carbonaceous particulate matrix 102 at 0.1 wt % to 50 wt % of the carbonaceous particulate matrix 102, and in some cases 50 wt % to 99 wt %.

As with the oxidative metal 104, the reductive metal 106 can be doped onto external and internal porous surfaces of the carbon substrate 110. The reductive metal 106 can be chosen to promote PFAS reduction. Suitable reductive metals can generally have high reduction potential (<−0.44 V) and PFAS affinity. Non-limiting examples of reductive metal can include zinc (Zn), iron (Fe), aluminum (Al), magnesium (Mg), or any combination thereof. As a general guideline, the reductive metal 106 can be present at 1 wt % to 50 wt % of the carbonaceous particulate matrix 102, and in some cases 50 wt % to 99.9 wt %.

Varying a relative ratio of reductive metal to oxidative metal can allow optimization of performance for different environments, for use with different quality or types of carbon substrates 110, and/or specific choice of metals. However, generally, within the carbonaceous particulate matrix 102, the reductive metal 106 and oxidative metal 104 can have a weight ratio of reductive metal to oxidative metal from 0.5 to 10, and in some cases 0.01 to 0.5. In one example, at least one of the oxidative metal 104 or the reductive metal 106 can be a zero-valent metal. In one example, the oxidative metal is a zero-valent metal. Zero-valent metals are elemental metals in their neutral oxidation state, meaning they have a valence of 0. With a valence of 0, zero-valent metals can readily donate electrons. This can be useful in degrading contaminants, such as PFAS, as it can transfer electrons to the contaminants, breaking them down into less harmful substances. Zero-valent metals can also sequester contaminants by adsorbing them onto its surface or inducing precipitation. A non-limiting list of zero-valent metals that can be used include zerovalent iron (ZVI), zerovalent Co, zerovalent Cu, zerovalent Ni, zerovalent Al, and zerovalent zinc.

In some embodiments, the metal-doped carbonaceous material 100 can also include a metal oxide coating on either the oxidative metal 104, the reductive metal 106, or both the oxidative metal 104 and reductive metal 106. Depending on the specific metal, such metal oxide coatings can be naturally formed when exposed to an oxygen-containing, S²⁻-containing, phosphate-containing environment. These METAL-O/S/P coatings can conduct electrons to PFAS from metals and also prevent fast passivation of the metal.

Further, in some embodiments, the metal-doped carbonaceous material 100 can additionally include a catalyst 108 distributed within the carbonaceous matrix 102. The catalyst can be particularly useful in catalyzing both the reduction reaction, by conducting electrons from zero valent metals to PFAS, and oxidation reactions by boosting hydroxyl radical generation for breaking down C—F bonds, thus being preferentially associated with the reducing metals. Non-limiting examples of suitable catalyst can include positively charged organic functional groups, such as quaternary ammonium, and inorganics, such as sulfur(S), palladium (Pd), rhodium (Rh), indium (In), tin (Sn), rhenium (Re), other rare earth elements, or any combination thereof. The catalyst 108 can be oriented on surfaces of the oxidative metal 104, the reductive metal 106, or a combination thereof. As discussed above, in some cases, the surfaces can include an intermediate oxide layer. In other words, “oriented on surfaces” can include direct contact with a zero-valent metal (ZVM) and when there is an intermediate oxide layer and when there is a surface organic coating, like cetyltrimethylammonium bromide (CTAB), tetradecyl trimethylammonium bromide (TDTAB), benzethonium chloride (BZT), sodium dodecylbenzene sulfonate (DDBS), and Triton X-100. With respect to the oxidative metal 104, as an example, the catalyst 108 can be present at an atomic ratio of greater than zero to less than 5%, less than 0.5%, less than 0.1%, etc.

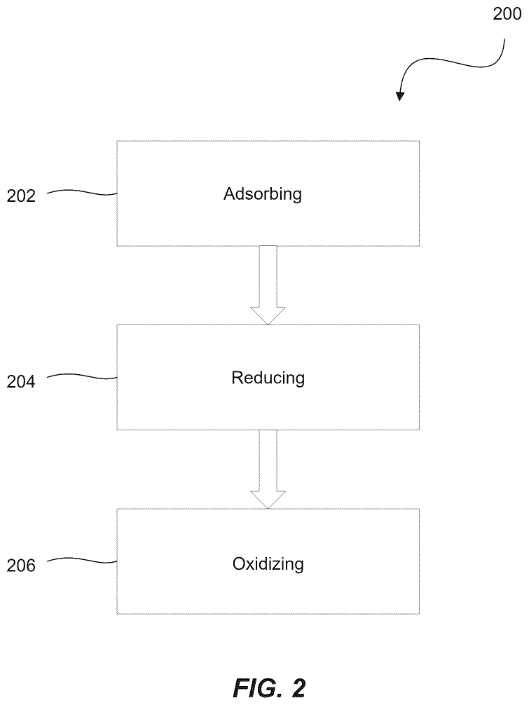

In one example, the metal-doped carbonaceous material 100 can be configured to break down PFAS by exposing a PFAS-containing fluid or soil to the carbonaceous particulate matrix 102. FIG. 2 depicts a method of breaking down PFAS 200. The method 200 can include adsorbing PFAS with a metal-doped carbonaceous material 202, degrading the PFAS 204, and reducing the PFAS 206. As previously described, the metal-doped carbonaceous material used can include a carbonaceous particulate matrix, which includes a carbon substrate, an oxidative metal, and a reductive metal. In some examples, the carbon substrate can be carbon nanotube, graphene/graphite, activated carbon, carbon black, biochar, and other conductive materials with large surface areas, such as silica-base and/or zeolite-base material. The oxidative metal can be iron (Fe) oxides (e.g. Fe²⁺ or Fe³⁺), nickel (Ni) oxide (e.g. Ni²⁺), copper (Cu) oxide (e.g. Cu⁺ or Cu²⁺), or combinations thereof. Additionally, the reductive metal can be zinc (Zn), iron (Fe), aluminum (Al), magnesium (Mg), or any combination thereof. In some further examples, the carbonaceous particulate matrix can also include a catalyst, which helps drive both the oxidizing reactions and the reducing reactions. Examples of such catalysts can include organic functional groups, such as quaternary ammonium, and inorganics, such as sulfur(S), palladium (Pd), rhodium (Rh), indium (In), tin (Sn), rhenium (Re), other rare earth metals, or any combination thereof. As also previously mentioned, the oxidative metals can be present in the carbonaceous particulate matrix at 0.1 wt % to 50 wt % of the carbonaceous particulate matrix, and in some cases 50 wt % to 99 wt %, with the reductive metals being present at 1 wt % to 50 wt % of the carbonaceous particulate matrix 102, and in some cases 50 wt % to 99.9 wt %.

In one embodiment, the metal-doped carbonaceous material can be packed into a filter housing having a fluid inlet and an outlet. A PFAS-containing fluid can then be directed into the filter housing passed through the material as a packed bed filter. In another embodiment, the metal-doped carbonaceous material can be physically mixed with a PFAS-contaminated soil. Upon saturation with water or other media, the PFAS can contact the metal-doped carbonaceous material. In another embodiment, metal doped biochar can be mixed with sludge from municipal wastewater treatment plant for anaerobic digestion or composting. In all of these embodiments, the PFAS can be adsorbed, and oxidized/reduced (e.g. degraded), which can significantly lower the PFAS concentrations in final products.

In addition to these steps, the method of breaking down PFAS 200 can include filtering at least one of soil and water with the metal-doped carbonaceous material. In the process of mixing with soil, microorganisms within the soil that have the capability of extracellular electron transfer, can promote PFAS oxidation under anaerobic/aerobic conditions. The metal-doped carbonaceous material can both immobilize and transform complex PFAS mixtures in soil and prevent the PFAS uptake to plants at the field scale. The metal-doped carbonaceous material can be formed in any suitable manner. In one example, a particulate carbon substrate, particulate oxidative metal, and a particulate reductive metal can be obtained. A dry mixture of the carbon substrate, oxidative metal, and reductive metal can be thoroughly mixed. Optional catalyst powder materials or other additives, such as organic polymers for stabilizing the material can be included. Non-limiting examples of organic polymers for stabilizing the material can include gum Arabic, polyvinylpyrrolidone, carboxymethyl cellulose, the like, or combinations thereof. In one specific example, mixing can be accomplished via ball milling, such as in a dry ball milling process. In some cases, a milling agent or fluid can be used. In another example, one or more of the reductive metal, the oxidative metal, and the catalyst can be deposited via solution deposition. The materials can be mixed to obtain a homogenous mixture having any suitable average particle size from nanoscale to several millimeters.

In some cases, the metal-doped carbonaceous material can be activated with a reducing agent. For example, one or more of the oxidative metal powder, reductive metal powder, and catalyst powder can be provided as a metal oxide. The final product can be provided as a reduced metal such that the oxide can be exposed to reducing conditions to form the corresponding zero valent metal. Non-limiting examples of suitable reducing agents can include sodium borohydride (NaBH₄), sodium dithionite, sodium sulfide, and the like. After activating the oxidative metal, the carbon substrate can have abundant amine groups, which are formed during carbon material synthesis process or surface coating after synthesis, and may be used for both PFAS adsorption 202 and transformation. In one example, polymers which are rich in amine groups can provide such beneficial surface conditions for adsorption and transformation.

Adsorption is a surface phenomenon where atoms, ions, or molecules from a substance stick to the surface of anther material. Because the surface area of the absorbent, such as the carbon substrate, has free energy and active sites, molecules can be attracted and held onto the absorbent. In the present case, PFAS molecules can stick to the surface of the carbon substrate, thus pulling PFAS out of the environment. As previously mentioned, the carbon substrate can be a porous substance. This can help with adsorbing 202 because porosity increases surface which increases adsorption. In some examples, adsorbing 202 can occur via hydrophobic interaction and electrostatic interaction. Hydrophobic interaction is the tendency of nonpolar molecules to associate with each other and exclude water, whereas electrostatic interaction is the attraction or repulsion between charged particles of molecules due to their electric charges. These interactions can allow for PFAS to be adsorbed by the carbon substrate, where the hydrophobic interaction and the electrostatic interaction mainly target long-chain PFAS and short-chain PFAS, respectively. Furthermore, adsorbing 202 can occur under anaerobic conditions for PFAS reduction and can occur under aerobic conditions for PFAS oxidation, and for simultaneous oxidation and reduction under control conditions, such as dosage of limited level of liquid oxidants, such as H₂O₂, and persulfate. Such adsorption can occur independently or concurrently.

Degrading, including reducing 204 and oxidizing 206, the PFAS can further include reducing the toxicity of PFAS via defluorination and transformation. Degrading via defluorination is the breakdown of a fluorinated compound by removing one or more fluorine atoms, usually through chemical, biological, or thermal processes. Defluorination requires the breaking of the C—F bond, which is one of the strongest bonds in organic chemistry. PFAS are extremely stable due to multiple C—F bonds, making defluorination especially effective in their degradation. Defluorination can result in partial degradation, where some fluorine is removed, or complete mineralization, where all flourine is removed, which can form other, less toxic compounds. In one example, defluorination can be accomplished by dosing the metal-doped carbonaceous material into PFAS solution. In some examples, this can result in over 90% PFAS being degraded to short-chain fatty acids. As for degrading via transformation, transformation is the breakdown of a chemical compound through chemical or biological reactions that can alter its structure without necessarily destroying it completely, which can produce intermediates or byproducts. Transformation can involve breaking specific bonds, adding or removing functional groups, or changing oxidative states, resulting in the original compound becoming less active, more polar, or more biodegradable without being fully eliminated. In some examples, the transformation can occur by bridging two-electron transfer pathways from the metal-doped carbonaceous material to the PFAS molecules adsorbed, and by bridging one-electron transfer from metal to PFAS and then stimulating the hydroxyl radical attacking to the PFAS molecule added with one electron. Additionally, surface coating on materials, adding oxidants (i.e., H₂O₂, persulfate) high temperature and UV/solar light can improve the defluorination performance.

In yet another alternative, the metal-doped carbonaceous material can be functionalized. In one example, the carbon substrate can be functionalized with a ligand; creating an active reactive cite at the ligand, which reacts with the PFAS. Ligands can be chosen to specifically and selectively bond with PFAS and/or degradation products of PFAS, or to facilitate electron transfer from material to PFAS molecules. The carbon substrate can be functionalized using any suitable technique such as, but not limited to, radical polymerization, click chemistry, electrochemical polymerization, amination, and the like. Non-limiting examples of useful ligands can include triethanolamine, porphyrin ligands [[meso-tetra(4-carboxyphenyl)porphyrinato]cobalt(III)]Cl·7H₂O (CoTCPP), [[meso-tetra(4-sulfonatophenyl) porphyrinato]cobalt(III)]·₉H₂O (CoTPPS), and [[meso-tetra(4-N-methylpyridyl)porphyrinato]cobalt(II)](I)₄·4H₂O (CoTMpyP).

While the flowchart presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped.

### EXAMPLE EMBODIMENTS

### Example 1

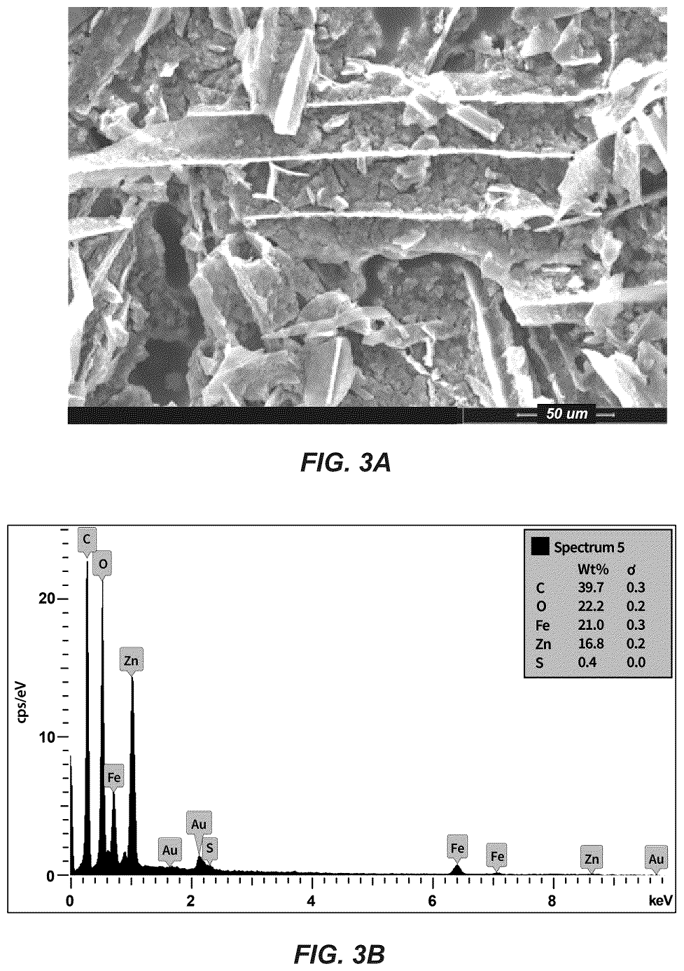

An amount of 2 g FeCl₃ and 2 g ZnCl₂ were added into 500 ml 10 gm biochar suspension. This mixture was stirred for 30 min. Then, 0.5 g/L NaBH₄ (containing 0.01 g/L Na₂S₂O₄) solution were titrated into the suspension at 20° C. for 45 minutes to produce a metal-doped carbonaceous material. FIG. 3 depicts images of S—Fe/Zn—BC from scanning electron microscope (SEM). As can be seen, most of the biochar surfaces are covered by metals (the inserted SEM image) with an overall C/Fe/Zn/O/S weight ratio of 30.3/24.4/21.3/23.5/0.5 (as measured by energy dispersive spectroscopy analysis).

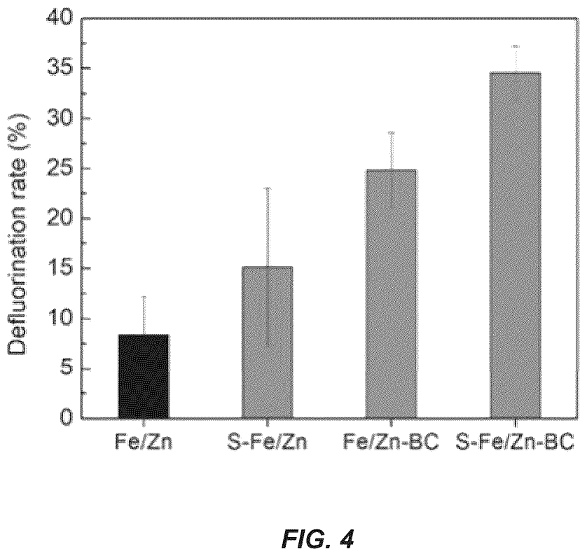

This material (S—Fe/Zn—BC) (5 g/L), along with other nanomaterials, namely nanoscale Fe/Zn particle (Fe/Zn), sulfidized nanoscale Fe/Zn particles (S—Fe/Zn), nanoscale Fe/Zn doped biochar (Fe/Zn—BC), was then exposed to PFOA (10 ppm) and PFOS (1.5 ppm) solution (contains 5 mM NaCl as background salts in water) at 20° C. for 24 h. FIG. 4 shows the defluorination rate of these materials, and S—Fe/Zn—BC achieved over 35% defluorination. Notedly, the initial PFOA concentration is very high, so if the initial concentration could be lowered to parts per billion level, then the defluorination rate will be even higher (could be >90%). The efficacy of this materials to other PFAS was tested, including perfluorobutanoic acid (PFBA), perfluorobutane sulfonic acid (PFBS), perfluorooctane sulfonic acid, perfluorodecanoic acid (PFDA), perfluorodecyl sulfonate (PFDS) (PFOS), and found similar defluorination performance.

### Example 2

Alternatively, an amount of 50 gm biochar, 10 gm iron powder, gm 10 zinc powder and 1 gm sulfur powder were mixed completely. These powders were mixed in a ball mill in N₂ atmosphere for 24 h to obtain a homogenous dry mixture. After harvest, 0.5% HCl acid and deionized water were used to wash the material, then the materials were coated with ligands and/or organics with amine group, and then dried in vacuum oven for PFAS degradation.

### Example 3

An amount of 0.5 gm FeCl₃, 0.5 gm CuCl₂, 0.5 gm CoCl₂, 0.5 gm NiCl₂, 0.5 gm ZnCl₂ were added into 500 ml. This mixture was stirred for 10 min. Then, 1.0 g/L NaBH₄ (containing 0.01 g/L Na₂S₂O₄) solution were titrated into the suspension at 20° C. for 45 minutes to produce a nanoalloy for PFAS degradation. The synthesized FeCoNiZnCu nanoparticle was then tested for PFOA destruction under different conditions. After FeCoNiZnCu nanoalloy (5.0 g/L) were exposed to 2.0 mg/L PFOA solution for 2 h under open-air conditions (in 150 ml beaker) at 25° C., 60° C., or 60° C. with 3.4 mg/L H₂O₂ dosage, 67.5±2.3%, 61.2±4.3%, and 49.1±3.5% of total initial dosed PFOA were recovered from liquid and solid, respectively (no other PFAS were detected through EPA 1633 method). However, due to the adsorption of F-onto the metal materials, only in the reaction system with H₂O₂ dosage, ˜0.1 mg/L F⁻ were detected in supernatant besides the VFA (products from PFAS degradation which were detected in all reaction conditions).

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A metal-doped carbonaceous material, comprising:
a carbonaceous particulate matrix, comprising:
a carbon substrate;
an oxidative metal; and
a reductive metal.

2. The metal-doped carbonaceous material according to claim 1, wherein the carbon substrate is one or more of biochar, carbon nanotubes, and colloidal activated carbon.

3. The metal-doped carbonaceous material according to claim 1, wherein the oxidative metal is at least one of iron (Fe) oxide, nickel (Ni), copper (Cu), cobalt (Co), aluminum (Al), and zinc (Zn).

4. The metal-doped carbonaceous material according to claim 1, wherein the oxidative metal is present at 0.1 wt % to 50 wt % of the carbonaceous particulate matrix.

5. The metal-doped carbonaceous material according to claim 1, wherein the reductive metal is at least one of zinc (Zn), iron (Fe), aluminum (Al), and magnesium (Mg).

6. The metal-doped carbonaceous material according to claim 1, wherein a reductive metal to oxidative metal ratio is from 0.1 to 10.

7. The metal-doped carbonaceous material according to claim 1, wherein at least one of the oxidative metal and the reductive metal is a zero-valent metal.

8. The metal-doped carbonaceous material according to claim 1, further comprising a metal oxide, metal sulfide or metal phosphate coating on at least one of the oxidative metal and the reductive metal, and optionally further includes a surface organic coating.

9. The metal-doped carbonaceous material according to claim 1, wherein the carbonaceous particulate matrix further comprises a catalyst distributed within the carbonaceous matrix.

10. The metal-doped carbonaceous material according to claim 9, wherein the catalyst is at least one of sulfur(S), palladium (Pd), and rhodium (Rh), indium (In), tin (Sn), and rhenium (Re).

11. The metal-doped carbonaceous material according to claim 9, wherein the catalyst is present at an atomic ratio of greater than zero to less than 5% with respect to the oxidative metal.

12. The metal-doped carbonaceous material according to claim 1, wherein the carbonaceous particulate matrix is configured to break down poly- and perfluoroalkyl substance (PFAS).

13. The metal-doped carbonaceous material according to claim 1, wherein the carbonaceous particulate matrix is porous.

14. The metal-doped carbonaceous material according to claim 1, wherein the carbonaceous particulate matrix is either nanoscale or micron scale.

15. A method of breaking down poly- and perfluoroalkyl substances (PFAS) comprising:
adsorbing PFAS with a metal-doped carbonaceous material, wherein the metal-doped carbonaceous material comprises a carbonaceous particulate matrix, comprising a carbon substrate, an oxidative metal, and a reductive metal;
degrading the PFAS; and
reducing the PFAS.

16. The method according to claim 15, wherein the carbon substrate is one or more of biochar, carbon nanotubes, and colloidal activated carbon.

17. The method of claim 15, wherein the oxidative metal is at least one of iron (Fe) oxide, nickel (Ni) and copper (Cu).

18. The method of claim 15, wherein the oxidative metal is activated with a reducing agent.

19. The method of claim 15, wherein the PFAS are reduced by sodium borohydride (NaBH₄).

20. The method of claim 15, wherein the reductive metal is at least one of zinc (Zn), iron (Fe), aluminum (Al) and magnesium (Mg).

21. The method of claim 15, wherein a reductive metal to oxidative metal ratio is from 0.1 to 10.

22. The method of claim 15, wherein at least one of the oxidative metal and the reductive metal is a zero-valent metal.

23. The method of claim 15, wherein the metal-doped carbonaceous material further comprises a catalyst distributed within the metal-doped carbonaceous material.

24. The method of claim 23, wherein the catalyst at least one of sulfur(S), palladium (Pd), and rhodium (Rh).

25. The method of claim 23, wherein the catalyst is oriented on surfaces of at least one of the oxidative metal and the reductive metal.

26. The method of claim 23, wherein the catalyst is present at an atomic ratio of greater than zero to less than 1% with respect to the oxidative metal.

27. The method of claim 23, wherein adsorbing occurs under at least one of anaerobic conditions for PFAS reduction and under aerobic conditions for PFAS oxidation.

28. The method of claim 23, wherein adsorbing occurs via hydrophobic interaction and electrostatic interaction.

29. The method of claim 28, wherein the electrostatic interaction targets short-chain PFAS.

30. The method of claim 15, wherein the degrading and reducing the PFAS further comprises reducing the toxicity of PFAS via defluorination and transformation.

31. The method of claim 15, further comprising functionalizing the carbon substrate with a ligand; creating an active reactive cite at the ligand, and reacting the ligand to the PFAS.

32. The method of claim 15, further comprising processing at least one of soil and water with the metal-doped carbonaceous material.

33. The method of claim 32, wherein microorganisms that are capable of extracellular electron transfer within the soil promote PFAS oxidation under both anaerobic and aerobic conditions.
